(19) United States
(12) Patent Application Publication
(10) Pub. No.: US 2004/0011407 A1
(43) Pub. Date: Jan. 22, 2004

(54) Air poppet valve

(76) Inventor: Timothy Lee Fisher, Evansville, IN (US)

Correspondence Address: BOWERS HARRISON LLP, GARY K. PRICE, ESP., 25 RIVERSIDE DRIVE, PO BOX 1287, EVANSVILLE, IN, 47706-1287, US

(21) Appl. No.: 10/197,739

(22) Filed: Jul. 19, 2002

(51) Int. Cl. F16K 15/00

(52) U.S. Cl. 137/541

(57) ABSTRACT

An air poppet valve for use in molding or drawing deep draw thin walled plastic or metal parts. The air poppet valve includes a poppet, a sleeve, a spring and a pin. Said poppet includes a pin clearance and a poppet sealing surface. Said sleeve includes a spring retaining ledge, an outer diameter, a recess portion, a plurality of reliefs, a collar, a plurality of air passage channels, a sleeve sealing surface, and a poppet clearance. Said pin is inserted through the pin clearance of the poppet, and the spring is contained between the pin and the spring retaining ledge of the sleeve. The air poppet valve having said plurality of air passage channels permit use of an air supply line from the underneath of the poppet, or the side of the air poppet valve.

### CROSS REFERENCES TO RELATED APPLICATIONS

Not applicable.

Statement as to rights to inventions made under Federally sponsored research and development: Not Applicable

### BACKGROUND OF THE INVENTION

1. Field of the Invention

This invention relates to an improved air poppet valve for use in molds, such as but not restricted to molds used for deep drawing of thin walled parts. When the air poppet valve is activated, air flow through the valve opens the valve to relieve negative pressure build up in the cavity of the mold and facilitate part ejection from the mold.

2. Brief Description of Prior Art

Air poppet valves are used to remedy a vacuum problem often encountered during the molding of deep draw thin walled parts. Air flow is timed to coincide with an ejection cycle so the valve opens, relieving negative pressure build up (vacuum) in the cavity of the mold and facilitating part ejection from the mold.

In prior art valves, the air flow is directed to an end of the air poppet valve, which too often requires more room than is available or convenient.

As will be seen from the subsequent description, the preferred embodiment of the present invention overcome limitations of existing air poppet valves available for use in molds.

### SUMMARY OF THE INVENTION

The present invention is an air poppet valve for use in molding or drawing deep draw thin walled plastic or metal parts. The air poppet valve includes a poppet, a sleeve, a spring and a pin. Said poppet includes a pin clearance and a poppet sealing surface. Said sleeve includes a spring retaining ledge, an outer diameter, a recess portion, a plurality of reliefs, a collar, a plurality of air passage channels, a sleeve sealing surface, and a poppet clearance. Said pin is inserted through the pin clearance of the poppet, and the spring is contained between the pin and the spring retaining ledge of the sleeve. The air poppet valve having said plurality of air passage channels permit use of an air supply line from the underneath of the poppet, or the side of the air poppet valve.

### BRIEF DESCRIPTION OF THE DRAWINGS

FIG. 1 is a perspective view of the preferred embodiment of the present invention, an air poppet valve.

FIG. 2 is an exploded view of the air poppet valve of FIG. 1.

FIG. 3 is a top view of a sleeve of the air poppet valve of FIG. 1.

FIG. 4 is an alternate view of the sleeve in FIG. 3.

FIG. 5 illustrates a typical installation of a prior art air poppet valve.

FIGS. 6 and 7 illustrate typical installations of the preferred embodiment of the present invention, the air poppet valve.

### DESCRIPTION OF THE PREFERRED EMBODIMENT

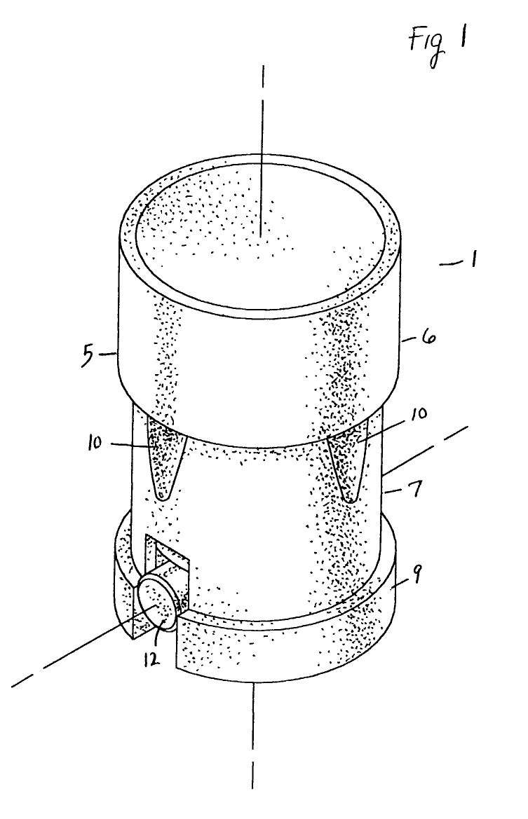

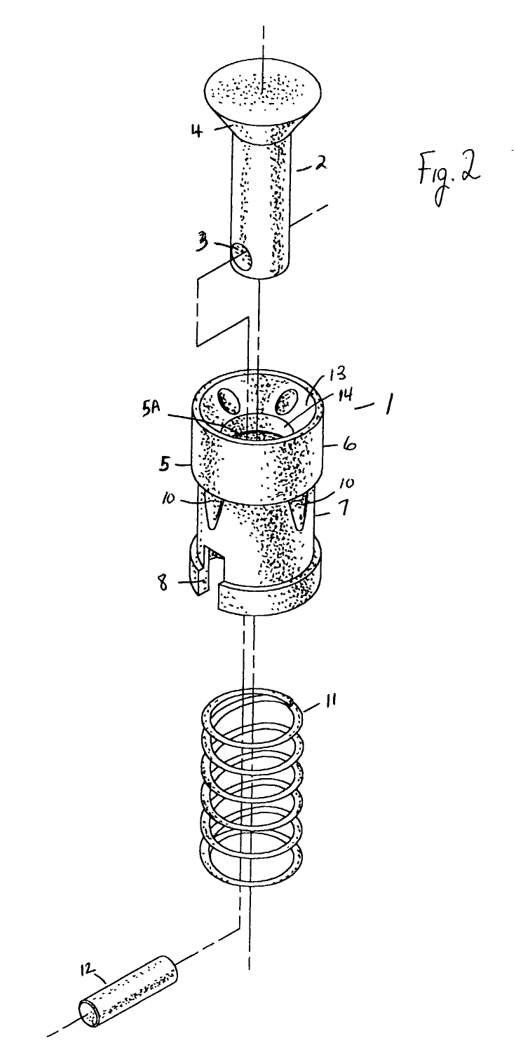

FIGS. 1-4, 6 and 7 illustrate a preferred embodiment of an air poppet valve 1 made in accordance with the present invention. As best shown in FIG. 2, the air poppet valve 1 includes a poppet 2, a sleeve 5, a spring 11 and a pin 12.

The poppet 2 includes a pin clearance 3 and a poppet sealing surface 4.

Referring to FIGS. 2-4, the sleeve 5 including a spring retaining ledge 5A, an outer diameter 6, a recess portion 7, a plurality of reliefs 8, a collar 9, a plurality of air passage channels 10, a sleeve sealing surface 13, and a poppet clearance 14.

FIG. 5 illustrates a typical installation of a prior art air poppet valve 20 in a mold 21 with an air inlet 21 A attached thereto. An arrow A indicates direction of the air flow to operate said valve 20.

FIG. 6 illustrates a typical installation of the air poppet valve 1 of the present invention in a mold 22 with a side inlet 22A. An arrow B indicates the direction of air flow through the side inlet 22A to the recess portion 7 of the air poppet valve 1.

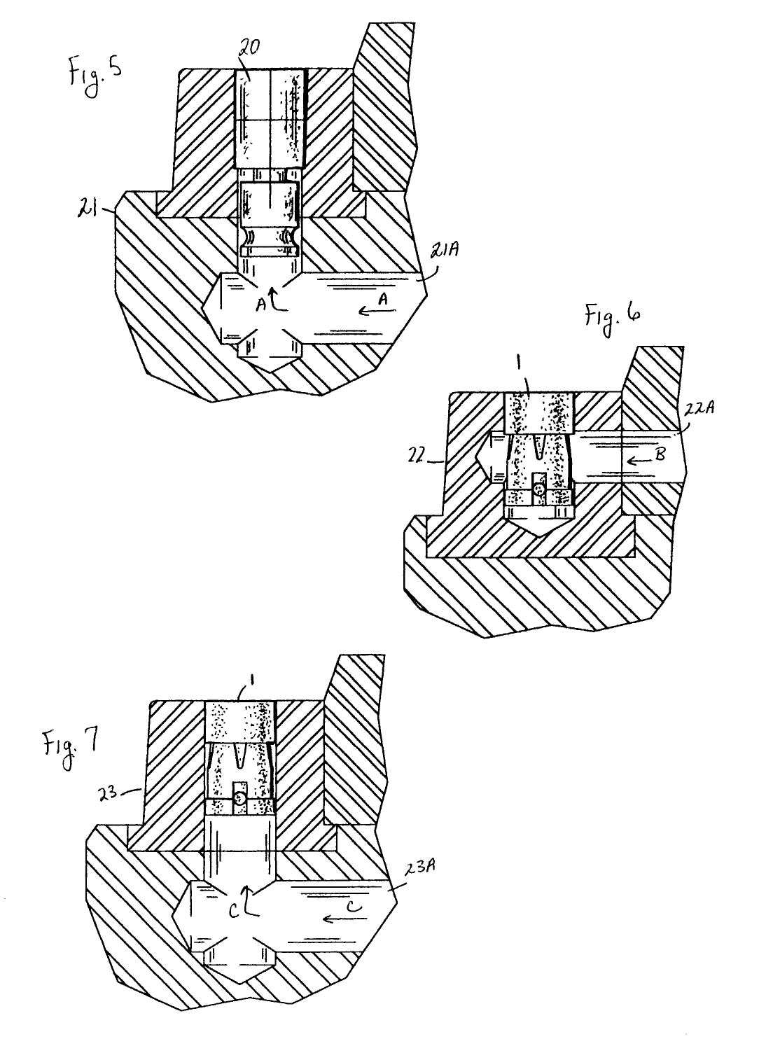

FIG. 7 illustrates a typical installation of the air poppet valve 1 of the present invention in a mold 23 with an air inlet 23A attached from the underneath of the air poppet valve 1. This installation is similar to the prior art air poppet valve 20 shown in FIG. 5. An arrow C indicates direction of the air flow to operate the air poppet valve 1.

The application of the air poppet valve 1 has generally an open position for ejecting a part (not shown) from the cavity of the mold 22, and a closed position when injecting material into the mold. As will be described, communicating air flow from the air supply line to the air poppet valve places the air poppet valve in the open position. Stopping air flow to the air poppet valve 10 returns the air poppet valve 10 to the closed position.

Referring to FIGS. 2-4 and 6, in use, air flows from the air inlet 22A into and through the air passage channels 10 of the recess portion 7, unseats the poppet 2 and the poppet sealing surface 4 of the poppet 2 from the sleeve sealing surface 13 of the sleeve 5. The air then flows out of the air poppet valve 1, and used to assist in ejecting a part (not shown) from the cavity of the mold 22.

The spring 11 (referenced in FIG. 2), which is contained between the spring retaining ledge 5A of the sleeve 5 and the pin 12 which is inserted through the pin clearance 3 of the poppet 2, is compressed as the poppet 2 is unseated.

When air stops flowing into the air poppet valve 1, the spring 11 acting on the pin 12 reseats the poppet sealing surface 4 of the poppet 2 against the sleeve sealing 13 of the sleeve 5.

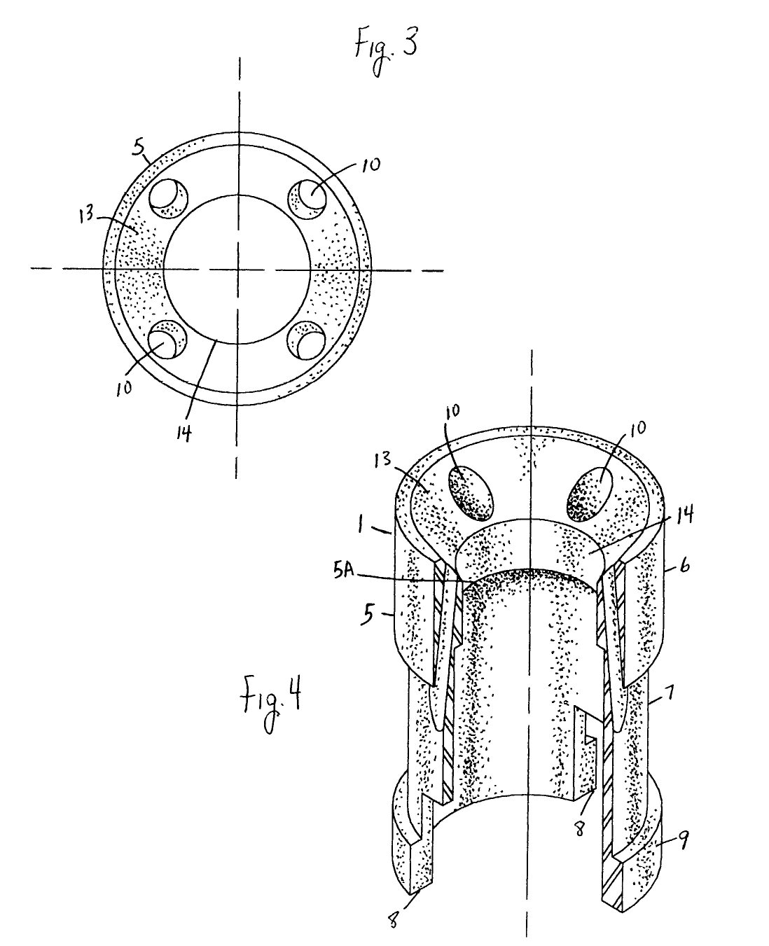

As previously described, FIG. 7 illustrates another typical installation of the air poppet valve 1 in the mold 23 with said air inlet 23A. Arrow C in FIG. 7 indicates the direction of air flow through the air inlet 23A into the air poppet valve 1 through the poppet clearance 14 (referenced also in FIGS. 3 and 4). Air flows through the poppet clearance 14 forcing the poppet 2 and the poppet sealing surface 4 from the sleeve sealing surface 13 of the sleeve 5. The air then flows out of the air poppet valve 1.

The air poppet valve 1 of the present invention, by permitting use of an air supply line through the side of the air poppet valve 1, and therefore allowing air entry into the recess 7 and through the channels 10 to unseat the poppet 2, permits a more compact mold 22 as compared to the mold 21 with the prior art air poppet valve 20.

Also by virtue of the release 8 into which the pin 12 through the poppet 2 is seated, with the spring 11 contained between the pin 12 and the spring retaining ledge 5A of the sleeve 5, the air poppet valve 1 in FIG. 7 is more compact than the prior art valve 20 shown in FIG. 5, thereby permitting a more compact mold 23, as compared to the mold 21 with the prior art air poppet valve 20.

A typical material of construction for the air poppet valve 1 would be stainless steel.

Although the description above contains many specificities, they should not be construed as limiting the scope of the invention but as merely providing illustrations of some of the presently preferred embodiments of this invention.

It will be obvious to those skilled in the art that modifications may be made to the embodiments described above without departing from the scope of the present invention. Thus the scope of the invention should be determined by the appended claims in the formal application and their legal equivalents, rather than by the examples given.

I claim:

1. An air poppet valve comprising:
a poppet including a poppet sealing surface;
a sleeve including a spring retaining ledge, a plurality of reliefs, a plurality of channels, a sleeve sealing surface, and a poppet clearance;
a spring; and
a pin;
wherein the spring is contained between the pin and the spring retaining ledge of the sleeve;
wherein the poppet seats into the sleeve with the poppet sealing surface of the poppet sealing against the sleeve sealing surface of the sleeve.

2. The air poppet valve as recited in claim 1, wherein said pin is seated in said reliefs of said sleeve resulting in a shorter air valve thereby enabling a savings in mold size.

3. An air poppet valve comprising:
a poppet including a pin clearance and a poppet sealing surface;
a sleeve including a spring retaining ledge, a recess, a plurality of reliefs, a plurality of channels, a sleeve sealing surface, and a poppet clearance;
a spring; and
a pin;
wherein the spring is contained between the pin, said pin inserted through the pin clearance of the poppet, and the spring retaining ledge of the sleeve;
wherein the poppet seats into the sleeve with the poppet sealing surface of the poppet sealing against the sleeve sealing surface of the sleeve;
wherein air flows through the recess of the sleeve and flows through the channels of the sleeve, unseating the poppet from the sleeve, and then flows out of the air poppet valve.

4. The air poppet valve as recited in claim 3, wherein said pin is seated in said reliefs of said sleeve resulting in a shorter air valve thereby enabling a savings in mold size.
